(19) United States
(12) Patent Application Publication
(10) Pub. No.: US 2012/0102019 A1
(43) Pub. Date: Apr. 26, 2012

(54) METHOD AND APPARATUS FOR CRAWLING WEBPAGES

(75) Inventors: Seung-hyun YOON, Anyang-si (KR); Seung-ryoul MAENG, Daejeon (KR); Jae-hyuk HUH, Daejeon (KR); Sang-won SEO, Daejeon (KR); Jae-Hong KIM, Daejeon (KR); Jong-se PARK, Daejeon (KR)

(73) Assignees: KOREA ADVANCED INSTITUTE OF SCIENCE AND TECHNOLOGY, Daejeon (KR); SAMSUNG ELECTRONICS CO., LTD., Suwon-si (KR)

(21) Appl. No.: 13/116,785

(22) Filed: May 26, 2011

(30) Foreign Application Priority Data
Oct. 25, 2010 (KR) 10-2010-0104246

(51) Int. Cl. G06F 17/30

(52) U.S. Cl. 707/709; 707/E17.108

(57) ABSTRACT

A method and apparatus for crawling webpages are provided. The method and apparatus involve obtaining a root Web address list; obtaining a list of Web addresses linked to the root Web address list; evaluating content of pages of the Web addresses based on the obtained list of Web addresses; adjusting a crawling depth according to the evaluation of the content of the pages of the Web addresses; and crawling webpages according to the adjusted crawling depth.

### CROSS-REFERENCE TO RELATED PATENT APPLICATION

This application claims priority from Korean Patent Application No. 10-2010-0104246, filed on Oct. 25, 2010, in the Korean Intellectual Property Office, the disclosure of which is incorporated herein in its entirety by reference.

### BACKGROUND

1. Field

Apparatuses and methods consistent with the exemplary embodiments relate to a Web search system, and more particularly, to a method and apparatus for crawling webpages including specific information such as geo-tagged picture information.

2. Description of the Related Art

Users access a large amount of information distributed in many computers via the Internet and other networks. In order to access the large amount of information, users generally use a browser to access a search engine. The search engine responds to users' queries by retrieving one or more information sources via the Internet or other networks.

In general, webpages in a Web space are useful resources that can be used in additional services including a search engine.

For example, a Web crawler performs an operation of effectively gathering the useful resources in the Web space.

However, a Web crawler according to the related art has to perform additional work so as to crawl webpages including specific information such as geo-tagged picture information. That is, according to the related art, it is necessary to visit all webpages in a huge internet space and then check all images in the webpages so as to find out whether the images are geo-tagged. Thus, a crawling speed is significantly decreased.

### SUMMARY

Exemplary embodiments provide a method and apparatus for adaptively crawling webpages including specific information, whereby a crawling speed with respect to the webpages may be increased.

According to an aspect of an exemplary embodiment, there is provided a method for crawling webpages, the method including obtaining a root Web address list; obtaining a list of Web addresses linked to the root Web address list; evaluating content of pages of the Web addresses based on the obtained list of Web addresses; adjusting a crawling depth according to the evaluation of the content of the pages of the Web addresses; and crawling webpages according to the adjusted crawling depth.

The method may further include adding Web addresses of the crawled webpages to the root Web address list.

The method may further include providing a terminal with the crawled webpages in a priority order according to specific information which is requested.

The method may further include categorizing the crawled webpages and Web address information according to specific information, and providing the crawled webpages and the Web address information to a terminal.

The obtaining the list of Web addresses may include obtaining a list of Web addresses to visit based on a maximum crawling depth; and converting the obtained list of Web addresses into a crawling database format and storing the converted list of Web addresses in a crawling database.

The evaluating the content may include obtaining a list of Web addresses to currently visit based on the stored list of Web addresses, and storing information about a current crawling depth; visiting Web addresses included in the obtained list of Web addresses, and obtaining content of pages of corresponding Web addresses; and evaluating whether the obtained content of the pages of the corresponding Web addresses include specific information.

The adjusting the crawling depth may include filtering the pages of the Web addresses according to the evaluation of the obtained content of the pages of the Web addresses; evaluating a speed value related to obtainment of a webpage including specific information by filtering the pages of the Web addresses; storing and updating the content and Web address information by parsing the content of the pages; and adjusting a crawling depth based on the speed value related to the obtainment of the webpage including the specific information.

The speed value related to the obtainment of the webpage may indicate a speed value related to searching for a Web address page including the specific information.

The crawling depth may be adjusted until the speed value related to the obtainment of the webpage reaches a determined value.

According to an aspect of another exemplary embodiment, there is provided a method for crawling webpages, the method including detecting a user location; obtaining a root Web address list to crawl based on information about the user location; obtaining a list of Web addresses linked to the root Web address list; evaluating content of pages of the Web addresses based on the obtained list of Web addresses; adjusting a crawling depth according to the evaluation of the content of the pages of the Web addresses; and crawling webpages according to the adjusted crawling depth.

According to an aspect of another exemplary embodiment, there is provided an apparatus for crawling webpages, the apparatus including a Web address obtaining unit which obtains a root Web address list and a list of Web addresses linked to the root Web address list via the Internet or a terminal; a webpage evaluating unit which visits the Web addresses based on the list of Web addresses obtained by the Web address obtaining unit, which obtains content of pages of the Web addresses, and which evaluates whether the content includes specific information; a crawling depth adjusting unit which adjusts a crawling depth according to a result of the evaluation by the webpage evaluating unit; and a crawling unit which crawls webpages according to the crawling depth adjusted by the crawling depth adjusting unit.

The webpage evaluating unit may filter webpages including the specific information.

The apparatus may further include a crawling database which stores the list of Web addresses obtained by the Web address obtaining unit, and which stores content and Web address information related to the webpages crawled by the crawling unit.

The apparatus may further include a Web providing unit which provides the webpages crawled by the crawling unit in a priority order or according to a determined standard.

### BRIEF DESCRIPTION OF THE DRAWINGS

The above and other aspects will become more apparent by describing in detail exemplary embodiments with reference to the attached drawings in which:

FIG. 1 is a block diagram illustrating an overview of a Web search system according to an exemplary embodiment;

FIG. 2 is a block diagram illustrating details of the Web search server of FIG. 1;

FIG. 3 is a flowchart illustrating a method for crawling webpages, according to an exemplary embodiment;

FIG. 4 is a detailed flowchart illustrating a method for crawling webpages, according to another exemplary embodiment.

FIG. 5 illustrates a structure of webpages related to the method of FIG. 4, according to a crawling depth;

FIG. 6 is a flowchart illustrating a method for crawling webpages, according to another exemplary embodiment; and

FIG. 7 is a flowchart illustrating a method for providing crawled webpages to a user, according to an exemplary embodiment.

### DETAILED DESCRIPTION

Hereinafter, exemplary embodiments will be described in detail with reference to the attached drawings.

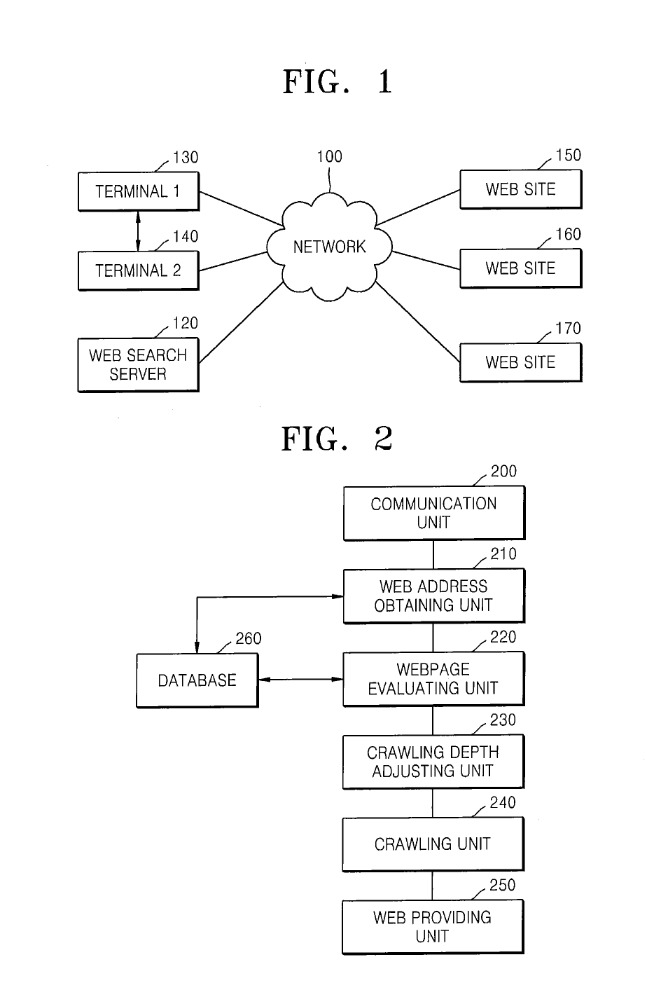

FIG. 1 is a block diagram illustrating an overview of a Web search system according to an exemplary embodiment.

The Web search system of FIG. 1 may include terminals 1 and 2 (130 and 140) that are connected to a Web search server 120 via a network 100.

The Web search server 120 gathers content from webpages in websites 150, 160, and 170 by using software referred to as a Web crawler, and crawls Uniform Resource Locators (URLs) and content having specific types of information from the content of the webpages.

In particular, when the terminals 1 and 2 (130 and 140) request the Web search server 120 to perform Web searching related to a particular area, the Web search server 120 obtains a root Web address list via the Internet or the terminals 1 and 2 (130 and 140), obtains a list of Web addresses linked to the root Web address list, evaluates content of webpages at each Web address based on the list of Web addresses, adjusts a crawling depth according to a result of the evaluation, and then crawls webpages. Here, URLs are used as the Web addresses.

The terminals 1 and 2 (130 and 140) display a list of Web addresses of webpages having specific information received from the Web search server 120 on a screen, and display a webpage of a Web address selected from the list of Web addresses on the screen.

The terminals 1 and 2 (130 and 140) internally have an information source and a Web crawler, and mutually exchange the information source. That is, each of the terminals 1 and 2 (130 and 140) obtains a URL list from a counter terminal or via the Internet by using the Web crawler, and performs crawling according to adjustment of a crawling depth by using the URL list.

FIG. 2 is a block diagram illustrating details of the Web search server 120 of FIG. 1.

Referring to FIG. 2, the Web search server 120 includes a communication unit 200, a Web address obtaining unit 210, a webpage evaluating unit 220, a crawling depth adjusting unit 230, a crawling unit 240, a Web providing unit 250, and a database 260.

The communication unit 200 performs wired and wireless communication with the terminals 1 and 2 (130 and 140) via the network 100.

The Web address obtaining unit 210 obtains a root URL list and a list of URLs linked to the root URL list via the Internet or a terminal.

The webpage evaluating unit 220 visits the URLs listed on the list of URLs obtained by the Web address obtaining unit 210, obtains content of webpages at each of the URLs, evaluates whether the content has specific information, such as geo-tagged picture information, and filters webpages of corresponding URLs according to existence or non-existence of the specific information.

The crawling depth adjusting unit 230 adjusts a crawling depth according to a result of the evaluation by the webpage evaluating unit 220.

The crawling unit 240 crawls webpages including the specific information according to the crawling depth adjusted by the crawling depth adjusting unit 230.

According to a user request, the Web providing unit 250 arranges the webpages crawled by the crawling unit 240 according to a priority order or various standards and then provides the webpages to the terminals 1 and 2 (130 and 140).

The database 260 stores the list of URLs obtained by the Web address obtaining unit 210, and stores content and URL information related to the webpages crawled by the crawling unit 240. For example, a magnetic recording-medium including a hard disk, or a non-volatile memory including an Electrically Erasable Programmable Read-Only Memory (EEPROM), a flash memory, or the like may be used as the database 260, but a type of the database 260 is not limited thereto.

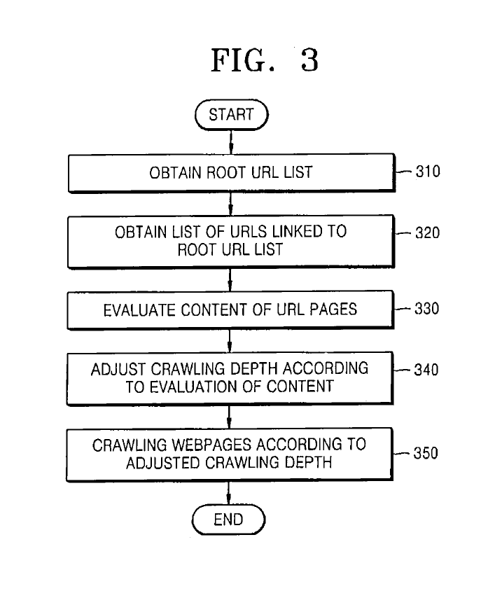

FIG. 3 is a flowchart illustrating a method of crawling webpages, according to an exemplary embodiment.

First, a root URL list is obtained according to a request from a user terminal or a server operator (operation 310).

Afterward, a list of all URLs linked to the root URL list is obtained via the Internet or a terminal according to a maximum crawling depth (operation 320).

Then, based on the list of URLs, it is evaluated whether specific information, such as geo-tagged picture information, exists in content of URL webpages corresponding to a current crawling depth (operation 330).

According to the evaluation of the content of the URL webpages, a crawling depth is dynamically adjusted (operation 340). For example, the crawling depth is decreased when a speed at which webpages including the specific information are crawled is decreased, and the crawling depth is increased when the speed at which the webpages including the specific information are crawled is increased.

Afterward, the webpages including the specific information are crawled according to the adjusted crawling depth (operation 350).

Thus, according to the present exemplary embodiment, content of a webpage including specific information are more likely to be found by dynamically adjusting a crawling depth, and thus a crawling time may be reduced.

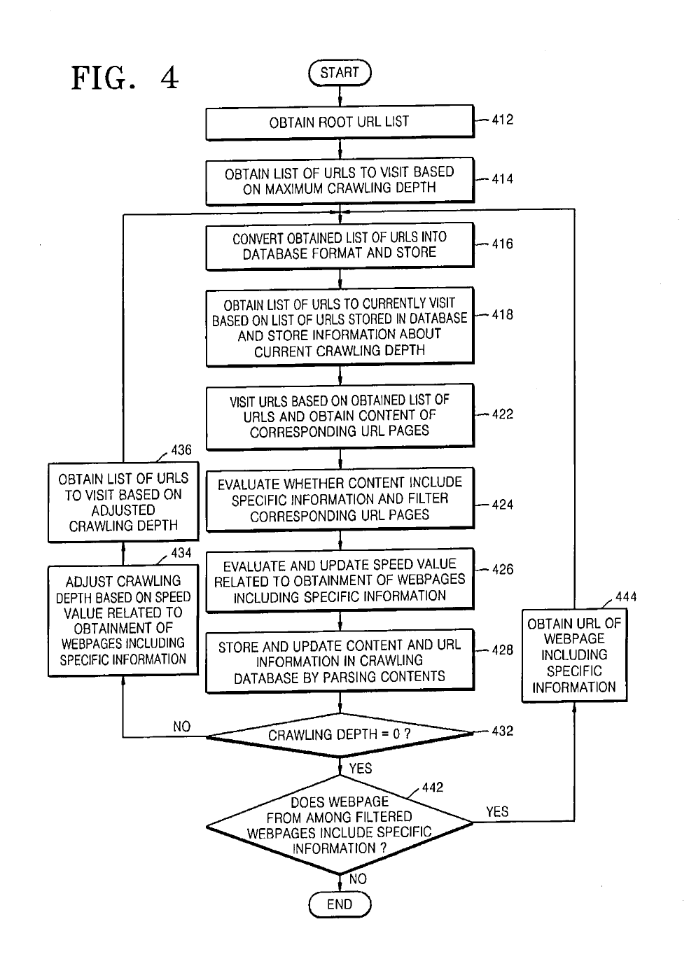

FIG. 4 is a detailed flowchart illustrating a method of crawling webpages, according to another exemplary embodiment.

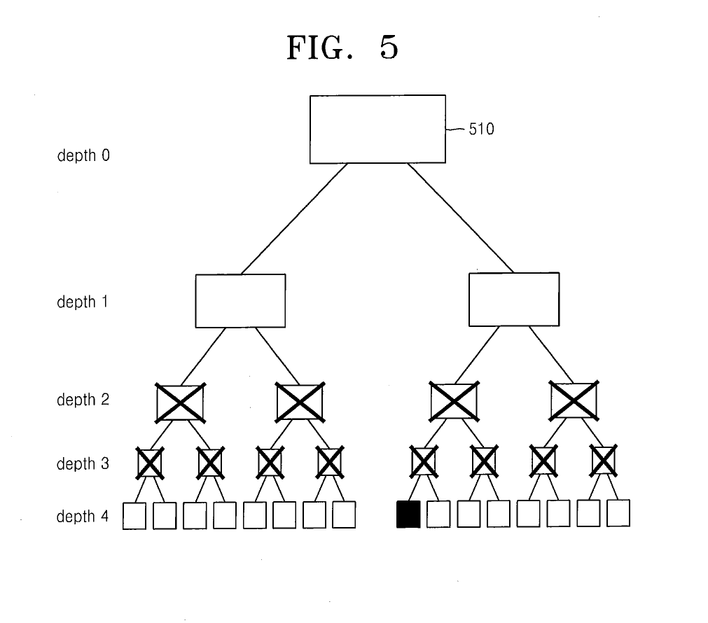

FIG. 5 illustrates a root webpage 510 and webpages linked to the root webpage 510 related to the method of FIG. 4. Here, as illustrated in FIG. 5, a crawling depth in the method of crawling webpages according to the present exemplary embodiment is set as “4”. Also, for convenience of description, with respect to the flowchart of FIG. 4, it is assumed that each of the webpages of FIG. 5 has only two links. As the crawling depth is increased, the number of webpages to be crawled is significantly increased.

First, when a user terminal requests webpages including specific information, such as geo-tagged picture information, a root URL list is obtained by a server operator or according to a server policy (operation 412). For example, a user may set a target area via a terminal, and may request webpages including specific information in the set target area. Also, the root URL list may be replaced by a source information list shared between user terminals. A root URL indicates an initial address for accessing a content providing server. Referring to FIG. 5, the root URL may be a URL page 510 existing at a crawling depth “0”.

Next, a list of all URLs that are linked to the root URL and that are to be visited based on a maximum crawling depth is obtained via the Internet or a terminal (operation 414). For example, as illustrated in FIG. 5, a list of all URLs at crawling depths “1” through “4” is obtained.

Afterward, the obtained list of URLs is converted into a crawling database format and then is stored in a crawling database (operation 416).

A list of URLs that will now be visited is obtained based on the list of URLs stored in the crawling database, and information about a current crawling depth is stored (operation 418).

Next, corresponding URLs are visited according to the obtained list of URLs, and then content of each URL webpage is obtained (operation 422).

Afterward, it is evaluated whether the obtained content includes specific information, such as geo-tagged picture information, and according to existence or non-existence of the specific information, webpages of corresponding URLs are filtered (operation 424).

Referring to FIG. 5, it is determined whether content of URL webpages at the crawling depth “4” include the specific information, and then URL webpages (marked with ▪) including the specific information, and URL webpages (marked with □) not including the specific information are extracted.

By performing URL webpage filtering, a speed value related to the obtainment of webpages including the specific information is evaluated, and then the speed value is updated (operation 426).

Here, the speed value related to the obtainment of webpages may be expressed as a time taken to search for URL webpages including the specific information.

Afterward, the obtained content of the URL webpages are parsed, necessary content information is separated from the obtained content, and then the separated content information and URL information are stored and updated in the crawling database (operation 428)

Then, it is checked whether a crawling depth is “0” (operation 432).

If the crawling depth is “0”, this means that crawling of webpages of one root URL is complete.

On the other hand, if the crawling depth is not “0”, the crawling depth is adjusted based on the speed value related to the obtainment of webpages including the specific information (operation 434). In other words, the crawling depth is adjusted until the speed value related to the obtainment of webpages reaches a determined value.

For example, as illustrated in FIG. 5, it is assumed that the number of URL webpages (marked with ▪) including the specific information at the crawling depth “4” is 1. Then, webpages at the crawling depths “2” and “3” linked to the crawling depth “4” are not likely to include the specific information, and thus a speed at which webpages are obtained is decreased. Thus, the crawling depths “2” and “3” linked to the crawling depth “4” are ignored (marked with “X” in FIG. 5), and then the crawling depth is adjusted to “1”.

Afterward, a list of URLs to visit according to the adjusted crawling depth is obtained (operation 436).

For example, as illustrated in FIG. 5, a list of URLs at the crawling depth “1” is obtained, and then operations 416 through 436 are repeated until the crawling depth reaches “0”.

Next, when the adjusted crawling depth is “0”, it is checked whether a webpage from among the filtered URL webpages includes the specific information (operation 442).

If the filtered URL webpages do not include the specific information, crawling is finished.

However, if a webpage from among the filtered URL webpages includes the specific information, the webpage including the specific information is obtained (operation 444), a URL of the obtained webpage is added to a URL list, and then operations 416 through 436 are repeated.

Finally, the Web search server 120 may provide crawled webpages to the user terminal.

Here, the Web search server 120 may provide a user with content and URL information in a priority order according to the specific information requested by the user.

In another example, the Web search server 120 may provide a user with content and URL information that are categorized based on specific information requested by the user.

Thus, according to the present exemplary embodiment, a weight is given to a webpage link according to how likely it is that a webpage including user desired specific information (e.g., geo-tagged picture information) will be found. Thus, a crawling speed may be increased since all of the Web addresses are not searched.

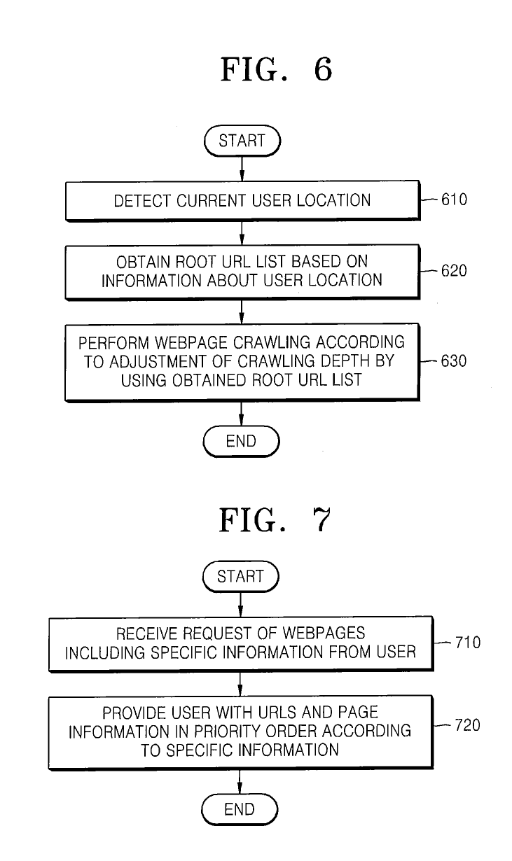

FIG. 6 is a flowchart illustrating a method of crawling webpages, according to another exemplary embodiment.

First, a current location of a terminal is recognized by using a Global Positioning System (GPS), and thus a user location is detected (operation 610). Here, the user location is converted into coordinate information.

Next, a root URL list corresponding to the user location is obtained based on information about the user location (operation 620).

Afterward, webpage crawling according to adjustment of a crawling depth (described with reference to FIGS. 3 and 4) is performed by using the obtained root URL list (operation 630).

Thus, according to the present exemplary embodiment, the crawling may be performed in real-time according to the user location.

FIG. 7 is a flowchart illustrating a method of providing crawled webpages to a user, according to an exemplary embodiment.

First, a request for crawled webpages including specific information, such as geo-tagged picture information, is received from a user (operation 710).

Next, when the request for crawled webpages is received, URL information and content are provided in a priority order according to the specific information (operation 720).

The exemplary embodiments can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), etc.

While exemplary embodiments have been shown and described, it will be understood by those of ordinary skill in the art that various changes in form and details may be made therein without departing from the spirit and scope of the inventive concept as defined by the following claims.

What is claimed is:

1. A method for crawling webpages, the method comprising:
obtaining a root Web address list;
obtaining a list of Web addresses linked to the root Web address list;
evaluating content of pages of the Web addresses based on the obtained list of Web addresses;
adjusting a crawling depth according to the evaluation of the content of the pages of the Web addresses; and
crawling webpages according to the adjusted crawling depth.

2. The method of claim 1, further comprising adding Web addresses of the crawled webpages to the root Web address list.

3. The method of claim 1, further comprising providing a terminal with the crawled webpages in a priority order according to specific information which is requested.

4. The method of claim 1, further comprising categorizing the crawled webpages and Web address information according to specific information, and providing the crawled webpages and the Web address information to a terminal.

5. The method of claim 1, wherein the obtaining the list of Web addresses comprises:
obtaining a list of Web addresses to visit based on a maximum crawling depth; and
converting the obtained list of Web addresses into a crawling database format and storing the converted list of Web addresses in a crawling database.

6. The method of claim 5, wherein the evaluating of the content comprises:
obtaining a list of Web addresses to currently visit based on the stored list of Web addresses, and storing information about a current crawling depth;
visiting Web addresses comprised in the obtained list of Web addresses, and obtaining content of pages of corresponding Web addresses; and
evaluating whether the obtained content of the pages of the corresponding Web addresses comprise specific information.

7. The method of claim 1, wherein the adjusting the crawling depth comprises:
filtering the pages of the Web addresses according to the evaluation of the obtained content of the pages of the Web addresses;
evaluating a speed value related to obtainment of a webpage comprising specific information by filtering the pages of the Web addresses;
storing and updating the content and Web address information by parsing the content of the pages; and
adjusting a crawling depth based on the speed value related to the obtainment of the webpage comprising the specific information.

8. The method of claim 7, wherein the speed value related to the obtainment of the webpage indicates a speed value related to searching for a Web address page comprising the specific information.

9. The method of claim 7, wherein the crawling depth is adjusted until the speed value related to the obtainment of the webpage reaches a determined value.

10. A method for crawling webpages, the method comprising:
detecting a user location;
obtaining a root Web address list to crawl based on information about the user location;
obtaining a list of Web addresses linked to the root Web address list;
evaluating content of pages of the Web addresses based on the obtained list of Web addresses;
adjusting a crawling depth according to the evaluation of the content of the pages of the Web addresses; and
crawling webpages according to the adjusted crawling depth.

11. An apparatus for crawling webpages, the apparatus comprising:
a Web address obtaining unit which obtains a root Web address list and a list of Web addresses linked to the root Web address list via the Internet or a terminal;
a webpage evaluating unit which visits the Web addresses based on the list of Web addresses obtained by the Web address obtaining unit, which obtains content of pages of the Web addresses, and which evaluates whether the content comprises specific information;
a crawling depth adjusting unit which adjusts a crawling depth according to a result of the evaluation by the webpage evaluating unit; and
a crawling unit which crawls webpages according to the crawling depth adjusted by the crawling depth adjusting unit.

12. The apparatus of claim 11, wherein the webpage evaluating unit filters webpages comprising the specific information.

13. The apparatus of claim 11, further comprising a crawling database which stores the list of Web addresses obtained by the Web address obtaining unit, and which stores content and Web address information related to the webpages crawled by the crawling unit.

14. The apparatus of claim 11, further comprising a Web providing unit which provides the webpages crawled by the crawling unit in a priority order or according to a determined standard.

15. A computer-readable recording medium having recorded thereon a program for executing a method, the method comprising:
obtaining a root Web address list;
obtaining a list of Web addresses linked to the root Web address list;
evaluating content of pages of the Web addresses based on the obtained list of Web addresses;
adjusting a crawling depth according to the evaluation of the content of the pages of the Web addresses; and
crawling webpages according to the adjusted crawling depth.
